(19) United States
(12) Patent Application Publication
(10) Pub. No.: US 2017/0199763 A1
(43) Pub. Date: Jul. 13, 2017

(54) METHOD AND APPARATUS FOR VISUALIZING SCHEDULING RESULT IN MULTICORE SYSTEM

(71) Applicant: ELECTRONICS AND TELECOMMUNICATIONS RESEARCH INSTITUTE, Daejeon (KR)

(72) Inventors: Yu Seung MA, Daejeon (KR); Kyeong Tae KIM, Daejeon (KR); Bum Ho KIM, Daejeon (KR); Sang Cheol KIM, Daejeon (KR); Seon-Tae KIM, Daejeon (KR); Hae Yong KIM, Daejeon (KR); Pyeong Soo MAH, Daejeon (KR); Jun Keun SONG, Daejeon (KR); Gyu Sang SHIN, Daejeon (KR); Duk Kyun WOO, Daejeon (KR); Jeong-Woo LEE, Daejeon (KR)

(21) Appl. No.: 15/206,767

(22) Filed: Jul. 11, 2016

(30) Foreign Application Priority Data
Jan. 8, 2016 (KR) 10-2016-0002842

(51) Int. Cl. G06F 9/48; G06F 17/30; G06F 9/52

(52) U.S. Cl. CPC G06F 9/4881; G06F 9/52; G06F 17/3053; G06F 17/30572

(57) ABSTRACT

A method and an apparatus for visualizing a scheduling result in a multicore system. A method for visualizing a scheduling result of a plurality of tasks with respect to a plurality of cores in a multicore system includes extracting scheduling data in a time section to be visualized, determining whether the number of the extracted scheduling data exceeds a preset first threshold value, if the number of the extracted scheduling data exceeds the preset first threshold value, performing reduction of the extracted scheduling data, and visualizing and outputting the reduced scheduling data.

### CROSS-REFERENCE TO RELATED APPLICATION

This application claims priority to and the benefit of Korean Patent Application No. 10-2016-0002842, filed on Jan. 8, 2016, in the Korean Intellectual Property Office, the entire contents of which are incorporated herein by reference in their entirety.

### BACKGROUND

1. Field

An aspect of the present disclosure relates to a method and an apparatus for visualizing a scheduling result in a multicore system.

2. Description of the Related Art

A multicore program is an application program embedded and executed in multicore hardware, and improves system performance by executing in parallel tasks using a plurality of cores. A multicore system supporting a multicore program allows tasks to be operated in parallel in several cores, thereby providing fast performance to a user. To this end, the multicore system should be developed such that tasks are efficiently distributed in several cores.

However, when the multicore system is used, the improvement of performance is not always ensured. For example, when scheduling between tasks goes wrong in the multicore system, the performance of the system may be deteriorated, or performance as high as expected may not be exhibited.

Therefore, a function of enabling a user to confirm a scheduling result of tasks should be provided so as to confirm whether the multicore system has efficiently parallelized the tasks and to control the parallelism of the tasks. Particularly, a scheduling result in a multicore system in which the movement of tasks from one core to another core is possible has its complicated contents, and hence it is essential to use a tool for visualizing the scheduling result in a form easy to understand and helping with analysis.

In one of methods for visualizing a scheduling result in a multicore system, as shown in FIG. 1, a scheduling result is shown as a two-dimensional graph using time and task as respective axes. FIG. 1 shows a visualization of a scheduling result in which a context switch event has occurred about ten times. Since the number of context switch events is small, the scheduling result can be easily expressed as a graph.

However, in the case of a multicore program in which interruption, synchronization, and movement of tasks between cores frequently occur, a few hundreds of context switch events may occur for a short period time of one second. Therefore, when a scheduling result including a few thousands of context switch events is visualized in the form of a two-dimensional graph on one screen, the user's degree of understanding is decreased.

In addition, when a scheduling result from a few of minutes to a few of days are collected with respect to the above-described multicore program, the size of the collected data is excessively large, and hence an overload occurs when the scheduling result is visualized in the form of a two-dimensional graph.

Consequently, methods for visualizing a scheduling result according to related arts have a disadvantage in that only a scheduling result for a short period of time is visualized. Since a complicated scheduling result is not simply visualized, a user cannot easily understand the scheduling result. Also, according to the related arts, when a scheduling result including a large amount of data is visualized, an overload occurs.

### SUMMARY

Embodiments provide a method and an apparatus for visualizing a scheduling result in a multicore system, in which, when a scheduling result including a large amount of scheduling data is visualized, a visualization is performed by reducing the scheduling data according to a preset condition.

According to an aspect of the present disclosure, there is provided a method for visualizing a scheduling result of a plurality of tasks with respect to a plurality of cores in a multicore system, the method including: extracting scheduling data in a time section to be visualized; determining whether the number of the extracted scheduling data exceeds a preset first threshold value; if the number of the extracted scheduling data exceeds the preset first threshold value, performing reduction of the extracted scheduling data; and visualizing and outputting the reduced scheduling data.

According to an aspect of the present disclosure, there is provided an apparatus for visualizing a scheduling result of a plurality of tasks with respect to a plurality of cores in a multicore system, the apparatus including: a scheduling data reduction unit configured to extract scheduling data in a time section to be visualized, determine whether the number of the extracted scheduling data exceeds a preset first threshold value, and, if the number of the extracted scheduling data exceeds the preset first threshold value, perform reduction of the extracted scheduling data; and a scheduling result output unit configured to visualize and output the reduced scheduling data.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating an example of a method for visualizing a scheduling result according to a related art.

FIG. 2 is a diagram illustrating a structure of a multicore system in which a visualization apparatus according to an embodiment of the present disclosure is operated.

FIG. 3 is a diagram illustrating an example of a scheduling result visualized according to an embodiment of the present invention.

FIG. 4 is a graph illustrating an example of a scheduling result visualized without reducing scheduling data.

FIG. 5 is a graph illustrating an example of a scheduling result visualized by reducing scheduling data according to an embodiment of the present disclosure.

FIG. 6 is a flowchart illustrating a visualization method according to an embodiment of the present disclosure.

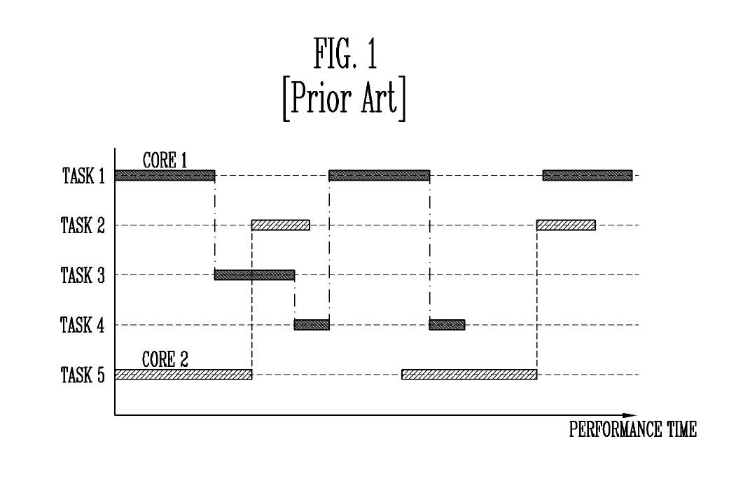

### DETAILED DESCRIPTION

The present disclosure now will be described more fully hereinafter with reference to the accompanying drawings, in which embodiments of the present disclosure are shown. The present disclosure should not be construed as limited to the embodiments set forth herein. Rather, these embodiments are provided so that this disclosure will be thorough and complete, and will fully convey the scope of the present disclosure to those skilled in the art.

It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

As used herein, the singular forms are intended to include the plural forms as well, unless the context clearly indicates otherwise.

Hereinafter, exemplary embodiments of the present disclosure will be described in detail with reference to the accompanying drawings.

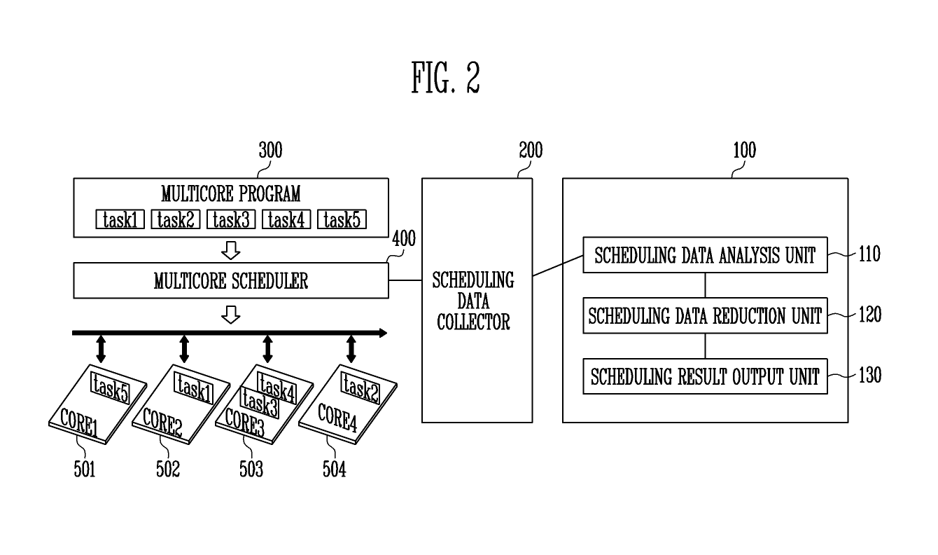

FIG. 2 is a diagram illustrating a structure of a multicore system in which a visualization apparatus according to an embodiment of the present disclosure is operated.

In the multicore system in which the visualization apparatus 100 is operated according to the embodiment of the present disclosure, tasks of a multicore program (multicore application program) 300 are parallelly processed in a plurality of cores (e.g., CPUs) 501 to 504.

A multicore scheduler 400 operated in the multicore system schedules the tasks of the multicore program 300 with respect to the plurality of cores 501 to 504, so that the tasks can be efficiently processed. Specifically, the multicore scheduler 400 assigns the tasks of the multicore program 300, which are input thereto, to the respective cores 501 to 504 according to a scheduling policy.

A scheduling data collector (or may be called as a profiler) 200 collects, as scheduling data (profiling data), processing events occurring as the multicore scheduler 400 assigns tasks to a core. In various embodiments, the processing event may be, for example, a context switch event. In an embodiment, the scheduling data collector 200 may collect scheduling data for each of the cores 501 to 504. The collected scheduling data may include information on a core in which corresponding scheduling data is scheduled, information on a kind of task, and information on a performance time.

The scheduling data collector 200 may transmit the collected scheduling data to the visualization apparatus 100.

The visualization apparatus 100 according to the embodiment of the present disclosure visualizes and outputs the scheduling data transmitted from the scheduling data collector 200. In various embodiments, when it is determined that a delay is to occur in a visualization process because the amount of scheduling data is enormous, the visualization apparatus 100 minimizes the delay, and reduces and visualizes the scheduling data such that a visualization result suitable for the size of a display can be output.

To this end, the visualization apparatus 100 according to the embodiment of the present disclosure, as shown in FIG. 2, includes a scheduling data analysis unit 110, a scheduling data reduction unit 120, and a scheduling result output unit 130.

The scheduling data analysis unit 110 analyzes scheduling data transmitted from the scheduling data collector 200 by sorting the scheduling data for each of the cores 501 to 504 and aligning the sorted scheduling data in a chronological order as shown in Table 1.

TABLE 1

| | Core 1 | | Core 2 | | Core 3 | | Core 4 | |
|---|---|---|---|---|---|---|---|---|
| | | Performance | | Performance | | Performance | | Performance |
| | Task | time | Task | time | Task | time | Task | time |
| 1 | Task1 | 0~100 | Task3 | 0~200 | Idle | 0~10 | Task2 | 0~75 |
| 2 | Idle | 100~200 | Idle | 200~400 | Task5 | 10~95 | Task4 | 75~400 |
| 3 | Task1 | 200~201 | Task4 | 400~403 | Task6 | 95~510 | Idle | 400~601 |
| 4 | Task2 | 201~260 | Task3 | 403~503 | Task5 | 510~514 | Task1 | 601~603 |
| 5 | Task1 | 260~280 | Idle | 503~703 | Task6 | 514~520 | Task2 | 603~606 |
| 6 | Task3 | 280~600 | Task4 | 703~706 | Task5 | 520~900 | Idle | 606~1000 |
| 7 | Task4 | 600~610 | Task3 | 706~806 | Task6 | 900~910 | Task6 | 1000~1003 |
| 8 | Task1 | 610~1014 | Idle | 806~1006 | Idle | 910~1429 | Task5 | 1003~4009 |
| 9 | Idle | 1014~1800 | Task4 | 1006~2000 | Task5 | 1429~1501 | Task2 | 1009~1030 |
| 10 | Task1 | 1800~2010 | Task3 | 2000~2200 | Task2 | 1501~1802 | Idle | 1030~2000 |
| . . . | . . . | . . . | . . . | . . . | . . . | . . . | . . . | . . . |
| 9007 | Task4 | 90600~90610 | Task3 | 90706~90806 | Task6 | 90909~90910 | Task6 | 91000~91003 |
| 9008 | Task1 | 90610~91014 | Idle | 90806~91006 | Idle | 90910~91429 | Task5 | 91003~91009 |
| 9009 | Idle | 91014~91800 | Task4 | 91006~92000 | Task5 | 91429~91501 | Task2 | 91009~91030 |
| 9010 | Task1 | 91800~92010 | | | Task2 | 91501~91802 | Idle | 91030~92000 |

The scheduling data for each of the cores 501 to 504, analyzed by the scheduling data analysis unit 110, may constitute a scheduling result (profiling result).

In Table 1, a scheduling result of context switch events occurring for 0 to 92,010 ms when the processing event is a context switch event is shown as an example. Referring to Table 1, it can be seen that 9010 context switch events have occurred in core 1. For example, task 1 was performed for 0 to 100 ms, and then, as a context switch event occurred, an idle thread was performed for 100 to 200 ms. After that, task 1 was again performed for 200 to 201 ms, and task 2 was sequentially performed for 201 to 260 ms.

When it is determined that the amount of the scheduling data analyzed (aligned) by the scheduling data analysis unit 110 is too enormous to be visualized, the scheduling data reduction unit 120 performs an operation for reducing the amount of the scheduling data.

Specifically, the scheduling data reduction unit 120 extracts scheduling data on a time section to be visualized among the scheduling data. The scheduling data analyzed by the scheduling data analysis unit 110 are linked with information on performance times as shown in Table 1. Thus, the scheduling data reduction unit 120 can extract scheduling data included in the time section to be visualized, based on the information on performance times.

For example, in the embodiment of Table 1, when the visualization apparatus 100 visualizes a scheduling result included in a time section of 0 to 92,010 ms, the scheduling data reduction unit 120 extracts scheduling data performed in the time section of 0 to 92,010 ms for each of the cores 501 to 504 among the scheduling data analyzed as shown in Table 1. In the embodiment of Table 1, the extracted scheduling data may be scheduling data on 9010 context switch events with respect to core 1 (501), 9009 context switch events with respect to core 2 (502), 9010 context switch events with respect to core 3 (503), and 3010 context switch events with respect to core 4 (504), i.e., a total of 36039 context switch events.

If the number of the extracted scheduling data is equal to or greater than a preset first threshold value, the scheduling data reduction unit 120 performs data reduction.

If the number of the extracted scheduling data exceeds the first threshold value, the scheduling data reduction unit 120 determines that, although the extracted scheduling data are visualized, a user will have difficulty in understanding visualization contents.

The first threshold value means the number of scheduling data determined that the user can easily understand or easily grasp visualization contents. The first threshold value may be previously set based on a resolution of a display on which a visualization result is to be output. In various embodiments, the first threshold value may be previously set to a value that is ½ of a resolution of one side of the display on which the visualization result is to be output. The resolution of the one side of the display, which determines the first threshold value, may be a resolution of one side of the display, at which a time axis of the visualization result is to be displayed.

In the embodiment of Table 1, if the resolution of the display on which the visualization result to be output is 3682×2071 (width height), and a lateral side of the display is the one side at which the time axis of the visualization result is to be displayed, the first threshold value may be previously set to 3682/2=1841.

If the number of the extracted scheduling data exceeds the first threshold value, the scheduling data reduction unit 120 performs data reduction. In various embodiments, the scheduling data reduction unit 120 performs data reduction by excluding, from a visualization target, a portion of scheduling data extracted based on a performance time of each scheduling data. Specifically, if the performance time of scheduling data is smaller than a preset second threshold value, the scheduling data reduction unit 120 excludes the corresponding scheduling data from the visualization target. That is, the scheduling data reduction unit 120 extracts only scheduling data, each of which performance time is equal to or greater than the preset second threshold value, thereby selecting scheduling data to be finally visualized.

The second threshold value means the length of a performance time determined that, when scheduling data is visualized because its performance time is sufficiently long, the user can visually recognize and understand the scheduling data. In various embodiments, the second threshold value may be determined based on a time section to be visualized and the first threshold value. For example, the second threshold value may be previously set to time section to be visualized/first threshold value. In the embodiment of Table 1, the second threshold value is time section to be visualized/first threshold value—92,010 ms/1841—about 50 ms.

In the embodiment of Table 1, scheduling data, each of which performance time is less than 50 ms, are scheduling data indicated by bold letters in the following Table 2, and the scheduling data reduction unit 120 excludes the scheduling data from the visualization target. That is, the scheduling data reduction unit 120 determines that the scheduling data, each of which performance time is less than 50 ms, are scheduling data that the user cannot recognize even though they are visualized, and excludes the scheduling data from the visualization target.

TABLE 2

| | Core 1 | | Core 2 | | Core 3 | | Core 4 | |
|---|---|---|---|---|---|---|---|---|
| | | Performance | | Performance | | Performance | | Performance |
| | Task | time | Task | time | Task | time | Task | time |
| 1 | Task1 | 0~100 | Task3 | 4~200 | Idle | 0~10 | Task2 | 0~75 |
| 2 | Idle | 100~200 | Idle | 200~400 | Task5 | 10~95 | Task4 | 7~400 |
| 3 | Task1 | 200~201 | Task4 | 400~403 | Task6 | 95~510 | Idle | 400~601 |
| 4 | Task2 | 201~260 | Task3 | 403~503 | Task5 | 510~514 | Task1 | 601~603 |
| 5 | Task1 | 260~280 | Idle | 503~703 | Task6 | 514~520 | Task2 | 603~606 |
| 6 | Task3 | 284~600 | Task4 | 703~706 | Task5 | 520~900 | Idle | 606~1000 |
| 7 | Task4 | 600~610 | Task3 | 706~806 | Task6 | 900~910 | Task6 | 1000~1003 |
| 8 | Task1 | 610~1014 | Idle | 806~1006 | Idle | 910~1429 | Task5 | 1003~1009 |
| 9 | Idle | 1014~1800 | Task4 | 1006~ 2000 | Task5 | 1429~1501 | Task2 | 1009~1030 |
| 10 | Task1 | 1800~2010 | Task3 | 2000~2200 | Task2 | 1501~1802 | Idle | 1030~2000 |
| . . . | . . . | . . . | . . . | . . . | . . . | . . . | . . . | . . . |
| 9007 | Task4 | 90600~90610 | Task3 | 90706~90806 | Task6 | 90909~90910 | Task6 | 91000~91003 |
| 9008 | Task1 | 90610~91014 | Idle | 90806~91006 | Idle | 90910~91429 | Task5 | 91003~91009 |
| 9009 | Idle | 91014~91800 | Task4 | 91006~92000 | Task5 | 91429~91501 | Task5 | 91009~91030 |
| 9010 | Task1 | 91800~92010 | | | Task2 | 91501~91802 | Idle | 91030~92000 |

According to the above-described embodiment of the present disclosure, a result obtained by reducing the scheduling data is shown in Table 3.

TABLE 3

| | Core 1 | | Core 2 | | Core 3 | | Core 4 | |
|---|---|---|---|---|---|---|---|---|
| | | Performance | | Performance | | Performance | | Performance |
| | Task | time | Task | time | Task | time | Task | time |
| 1 | Task1 | 0~100 | Task3 | 0~200 | Task5 | 10~95 | Task2 | 0~75 |
| 2 | Idle | 100~200 | Idle | 200~400 | Task6 | 95~510 | Task4 | 75~400 |
| 3 | Task2 | 201~260 | Task3 | 403~503 | Task5 | 520~900 | Idle | 400~601 |
| 4 | Task3 | 280~600 | Idle | 503~703 | Idle | 910~1429 | Idle | 606~1000 |
| 5 | Task1 | 610~1014 | Task3 | 706~806 | Task5 | 1429~1501 | Idle | 1030~2000 |
| 6 | Idle | 1014~1800 | Idle | 806~1006 | Task2 | 1501~1802 | . . . | . . . |
| 7 | Task1 | 1800~2010 | Task4 | 1006~2000 | . . . | . . . | | |
| 8 | . . . | . . . | Task3 | 2000~2200 | | | | |
| . . . | | | . . . | . . . | | | | |
| | Task1 | 90610~91014 | Task3 | 90706~90806 | Idle | 90910~91429 | Idle | 91030~92000 |
| | Idle | 91014~91800 | Idle | 90806~91006 | Task5 | 91429~91501 | | |
| | Task1 | 91800~92010 | Task4 | 91006~92000 | Task2 | 91501~91802 | | |

The scheduling data reduction unit 120 may transmit the reduced scheduling data to the scheduling result output unit 130.

The scheduling result output unit 130 visualizes and outputs a scheduling result including scheduling data. To this end, the scheduling result output unit 130 may include at least one display. According to implementation, the scheduling result output unit 130 may include a sound output unit, a vibration output unit, etc. The display included in the scheduling result output unit 130 may have an arbitrary resolution, and the resolution of the display may be used to determine the first threshold value.

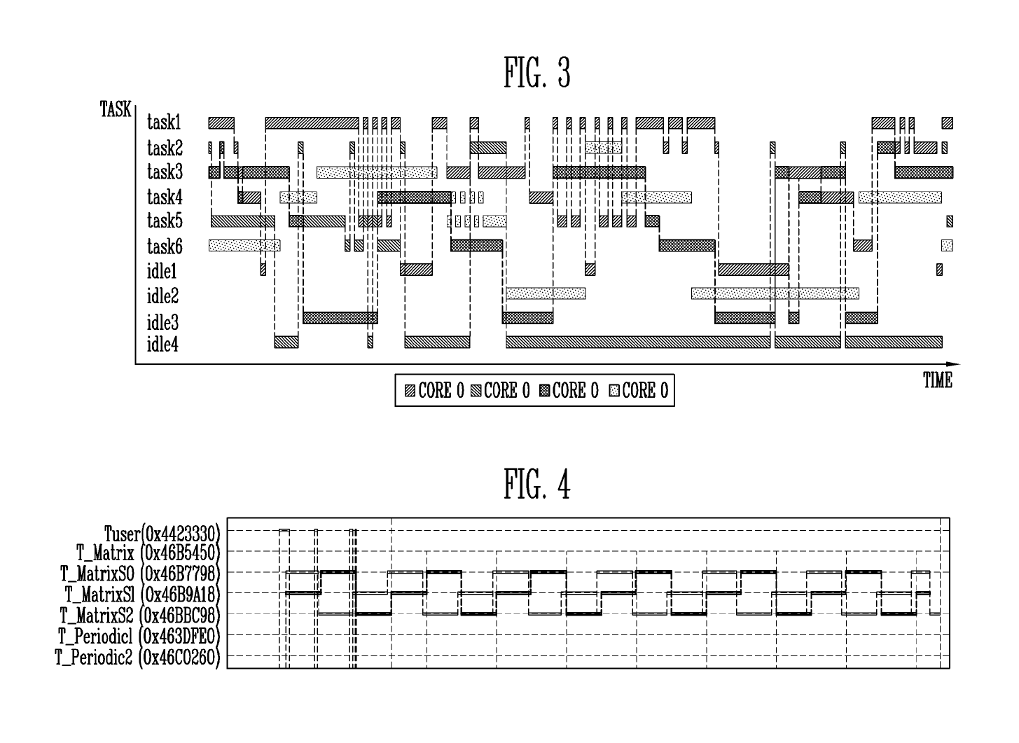

The scheduling result output unit 130 may output the scheduling data reduced by the scheduling data reduction unit 120 in a preset form, e.g., in the form of a two-dimensional graph. For example, the scheduling result output unit 130 may output a scheduling result including the reduced scheduling data, as shown in FIG. 3, in the form of a two-dimensional graph using performance time and task as respective horizontal and vertical axes.

Specifically, in FIG. 3, a time section in which each task is assigned and processed in a core is represented as a horizontal axis bar. Therefore, as the horizontal axis bar becomes longer, the performance time of a corresponding task becomes longer.

In this case, the scheduling result output unit 130 may visualize in which core each scheduling data has been performed. For example, the scheduling result output unit 130, as shown in FIG. 3, assigns different colors to the respective cores 501 and 504, and determines a visualization color of each scheduling data, corresponding to a core in which the corresponding scheduling data is scheduled, i.e., a core in which the corresponding scheduling data is processed. The scheduling result output unit 130 may output scheduling data according to determined visualization colors when the scheduling data are visualized.

However, the sorting of the cores 501 to 504 is not necessarily limited to colors, and the scheduling result output unit 130 may output a scheduling result such that the cores 501 to 504 are sorted in various manners such as patterns and index marks.

In the embodiment of FIG. 3, a vertical dotted line may mean that a context switch is made from which task to which task.

The above-described components are merely divided in a software manner, and the scheduling data analysis unit 110, the scheduling data reduction unit 120, and the scheduling result output unit 130 may be configured as one controller. However, in various embodiments, the display provided in the scheduling result output unit 130 may be configured as a separate display unit.

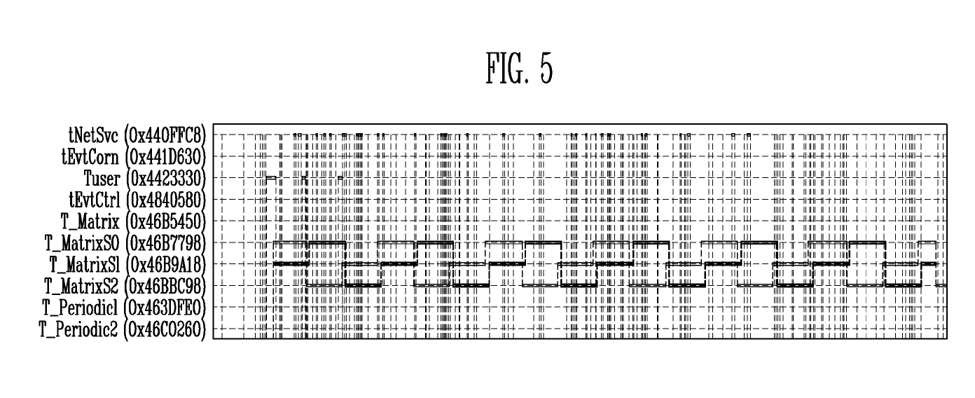

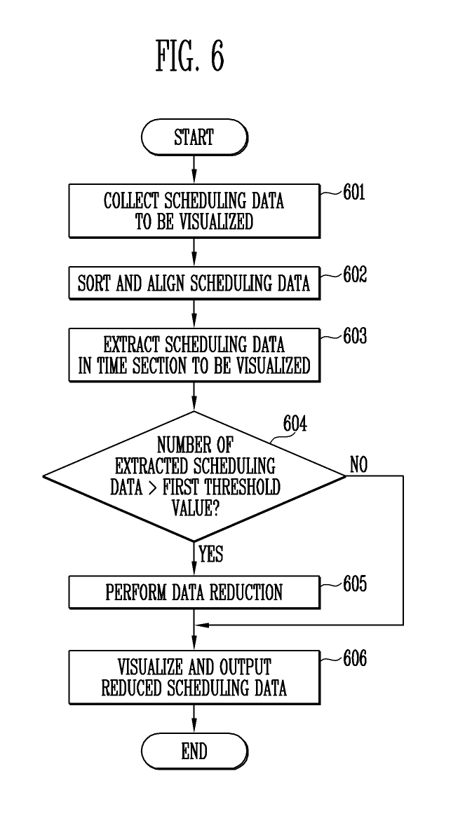

FIG. 4 is a graph illustrating an example of a scheduling result visualized without reducing scheduling data. FIG. 5 is a graph illustrating an example of a scheduling result visualized by reducing scheduling data according to an embodiment of the present disclosure.

In the graph of FIG. 4, the shape of the output graph is considerably complicated because the quantity of processing events is excessively large, and the readability of the graph is degraded because many vertical dotted lines representing context switches are visualized. In the graph of FIG. 4, delays occurs because the number of factors to be visualized is large when the graph is re-visualized due to movement, enlargement, or reduction of a screen, and therefore, the visualization performance of the scheduling result is deteriorated.

Meanwhile, in the graph of FIG. 5, it can be seen that, as compared with the graph of FIG. 4, the length of the horizontal axis is reduced, and the readability of the graph is improved because horizontal axis bars having small sizes are omitted. In the graph of FIG. 5, the visualization performance of the scheduling result is improved without any delay because the number of factors to be visualized is small when the graph is re-visualized due to movement, enlargement, or reduction of a screen.

FIG. 6 is a flowchart illustrating a visualization method according to an embodiment of the present disclosure.

Referring to FIG. 6, first, the visualization apparatus 100 collects scheduling data to be visualized (601). The scheduling data are processing events of tasks, processed in a plurality of cores. For example, the scheduling data may be context switch events. The collected scheduling data may include information on a core in which corresponding scheduling data is scheduled, information on a kind of task, and information on a performance time.

Next, the visualization apparatus 100 sorts the collected scheduling data for each core and aligns the sorted scheduling data in a chronological order (602). The visualization apparatus 100 may sort the scheduling data for each core in which corresponding scheduling data is scheduled, and align the scheduling data for each core in a chronological order, based on information included in the scheduling data.

The visualization apparatus 100 extracts scheduling data in a time section to be visualized from the scheduling data (603). The visualization apparatus 100 extracts scheduling data in a time section to be visualized, based on information on performance times, included in the scheduling data.

Next, the visualization apparatus 100 determines whether the number of the extracted scheduling data exceeds a preset first threshold value (604). In various embodiments, the first threshold value may be previously set based on a resolution of a display on which a visualization result is to be output. For example, the first threshold value may be set to a value that is ½ of a resolution of one side of the display on which the visualization result is to be output.

If the number of the collected scheduling data exceeds the first threshold value, the visualization apparatus 100 performs data reduction (605). Specifically, the visualization apparatus 100 selects scheduling data, each of which performance time is equal to or greater than a preset second threshold value among the extracted scheduling data. In various embodiments, the second threshold value may be previously set based on a time section to be visualized and the first threshold value. For example, the second threshold value may be previously set to length of time section to be visualized/first threshold value.

Subsequently, the visualization apparatus 100 visualizes and outputs the reduced scheduling data (606). That is, the visualized apparatus 100 visualizes and outputs the selected scheduling data. In various embodiments, the visualization apparatus 100 may output the selected scheduling data in the form of a two-dimensional graph. For example, the visualization apparatus 100 may output the selected scheduling data in the form of a two-dimensional graph using performance time and task as respective horizontal and vertical axes.

Also, in various embodiments, the visualization apparatus 100 may visualize scheduling data for each core in which the scheduling data are scheduled. For example, the visualization apparatus 100 may visualize scheduling data by assigning different colors to respective cores.

Meanwhile, if the number of the collected scheduling data does not exceed the preset first threshold value (604), the visualization apparatus 100 does not perform the data reduction but immediately visualizes and outputs the collected scheduling data (606).

In the visualization method and the visualization apparatus according to the present disclosure, the size of scheduling data is reduced to be suitable for the size of a display to be visualized, and the reduced scheduling data are visualized, so that a user can easily understand a scheduling result.

Also, although a scheduling result including a large amount of scheduling data is visualized, the scheduling result can be quickly visualized without any delay.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A method for visualizing a scheduling result of a plurality of tasks with respect to a plurality of cores in a multicore system, the method comprising:
extracting scheduling data in a time section to be visualized;
determining whether the number of the extracted scheduling data exceeds a preset first threshold value;
if the number of the extracted scheduling data exceeds the preset first threshold value, performing reduction of the extracted scheduling data; and
visualizing and outputting the reduced scheduling data.

2. The method of claim 1, wherein the extracting of the scheduling data includes:
collecting scheduling data;
sorting the collected scheduling data for each of the cores and aligning the sorted scheduling data in a chronological order; and
extracting scheduling data in the time section to be visualized, among the scheduling data aligned in the chronological order.

3. The method of claim 1, wherein the scheduling data are processing events of the plurality of tasks, which are processed in the plurality of cores.

4. The method of claim 3, wherein the processing event is a context switch event.

5. The method of claim 1, wherein the scheduling data includes information on a core in which corresponding scheduling data is scheduled, information on a kind of task, and information on a performance time.

6. The method of claim 1, wherein the first threshold value is previously set based on a resolution of a display on which the scheduling result is to be output.

7. The method of claim 6, wherein the first threshold value is previously set to a value that is ½ of a resolution of one side of the display.

8. The method of claim 7, wherein the one side is a side corresponding to a time axis of a two-dimensional graph obtained by visualizing the scheduling result.

9. The method of claim 1, wherein the performing of the reduction of the extracted scheduling data includes selecting, as scheduling data to be finally visualized, scheduling data, each of which performance time is equal to or greater than a preset second threshold value, among the extracted scheduling data.

10. The method of claim 9, wherein the second threshold value is previously set based on the time section to be visualized and the first threshold value.

11. The method of claim 10, wherein the second threshold value is previously set to a value obtained by dividing the first threshold value into the time section to be visualized.

12. The method of claim 1, wherein the visualizing and outputting of the reduced scheduling data includes visualizing and outputting the reduced scheduling data in the form of a two-dimensional graph using performance times and tasks of the reduced scheduling data as respective horizontal and vertical axes.

13. The method of claim 12, wherein the visualizing and outputting of the reduced scheduling data includes sorting the scheduling data for each of the cores corresponding to the scheduling data and outputting the sorted scheduling data.

14. An apparatus for visualizing a scheduling result of a plurality of tasks with respect to a plurality of cores in a multicore system, the apparatus comprising:
a scheduling data reduction unit configured to extract scheduling data in a time section to be visualized, determine whether the number of the extracted scheduling data exceeds a preset first threshold value, and, if the number of the extracted scheduling data exceeds the preset first threshold value, perform reduction of the extracted scheduling data; and
a scheduling result output unit configured to visualize and output the reduced scheduling data.

15. The apparatus of claim 14, further comprising a scheduling data analysis unit configured to collect scheduling data, and sort the collected scheduling data for each of the cores and align the sorted scheduling data in a chronological order.

16. The apparatus of claim 14, wherein the first threshold value is previously set based on a resolution of a display on which the scheduling result is to be output.

17. The apparatus of claim 16, wherein the first threshold value is previously set to a value that is ½ of a resolution of one side of the display.

18. The apparatus of claim 14, wherein the scheduling data reduction unit selects, as scheduling data to be finally visualized, scheduling data, each of which performance time is equal to or greater than a preset second threshold value, among the extracted scheduling data.

19. The apparatus of claim 18, wherein the second threshold value is previously set based on the time section to be visualized and the first threshold value.

20. The apparatus of claim 14, wherein the scheduling result output unit visualizes and outputs the reduced scheduling data in the form of a two-dimensional graph using performance times and tasks of the reduced scheduling data as respective horizontal and vertical axes.
